(19) United States
(12) Patent Application Publication
(10) Pub. No.: US 2014/0290762 A1
(43) Pub. Date: Oct. 2, 2014

(54) Apparatus and Method for Conserving and Filtering Water

(71) Applicant: Steve Gordon, Clearwater, FL (US)

(72) Inventor: Steve Gordon, Clearwater, FL (US)

(73) Assignee: Instant-Off, Inc., Clearwater, FL (US)

(21) Appl. No.: 14/353,896

(22) PCT Filed: Aug. 20, 2012
(86) PCT No.: PCT/US12/51552

§ 371 Date: Apr. 24, 2014

(51) Int. Cl. F17D 1/20

(52) U.S. Cl. CPC F17D 1/20
USPC 137/544

(57) ABSTRACT

This invention relates to the field of water valves and more particularly to a rod activated water valve for installation on any threaded water faucet, tap or threaded pipe with a filter screen to prevent any particle larger than the filter mesh from passing through the filter. This invention also relates to the field of water valves and more particularly to a rod activated water valve that allows a person to wash their hands and avoid touching faucet handles. In one embodiment a rod activated water valve is provided. This rod activated water valve is made of a valve base, a top end of the valve base being threaded on an outside surface for mating with a water faucet thread arrangement or pipe thread, a second end of the valve base having a threaded outside surface; a water flow chamber having a solid cylindrical outer surface, the water flow chamber having a substantially flat foraminous surface at one end, an aperture located substantially central to the flat foraminous surface having a lip on a top edge of the water flow chamber; a rod having a rod head at one end, the rod passing through the aperture and held within the aperture by the rod head; and a means for selectively blocking the flow of water from the water faucet to the water flow chamber and a water filter element forming a seal against the upper valve plate and the cylindrical valve.

### FIELD OF THE INVENTION

This invention relates to the field of water valves and more particularly to a rod activated water valve for installation on any threaded water faucet, tap or threaded pipe with a filter screen to prevent any particle larger than the filter mesh from passing through the filter. This invention also relates to the field of water valves and more particularly to a rod activated water valve that allows a person to wash their hands and avoid touching faucet handles.

### BACKGROUND OF THE INVENTION

We are fast approaching a world in which the most hotly-contested resource for development and survival is not oil, but water. More than 1.1 billion People in the world do not have access to safe drinking water, roughly one-sixth of the world's population. Water use is increasing much faster than population. Global water demands will increase by 40% in the next ten years. By 2025, two-thirds of the world will live under conditions of water scarcity. The average person in the developing world uses 2.64 gallons of water a day and the average African family uses only 5 gallons per day.

When people waste water, water utilities pump more water out of rivers, lakes and wetlands to keep up with demand. Wasting water directly damages our natural resources and puts the diversity of life that these rivers, lakes and wetlands support at risk.

Most people waste water unnecessarily. The average American uses 100 to 175 gallons of water per day at home. Even those who try to conserve water unintentionally waste water. For example, many people let the water run while brushing their teeth instead of turning off the water when they begin brushing and turning it back on to rinse. Most men let the water run while they shave wasting several gallons. Most people let the water run while washing dishes rather then having the water on only when they need it wasting 5-10 gallons of water every time they wash dishes.

Most people know that it's important not to waste water but find it difficult to turn off the water when it's not needed. Turning off the water when it's not being used could save billions of gallons of water a year. What is needed is a device that is easy to install, that will fit on all threaded faucets and pipes, a device that will automatically shut-off the water when it's not needed, a device that can stop a drippy faucet and that's durable and easy to use.

Drinking water is delivered to homes throughout the developed world through underground pipes. As water travels from the water plant or source to its final destination where it will be used there are many opportunities for particles to be added to the water. Whenever there is an underground pipe that cracks or breaks, dirt and other particles find their way into drinking water. It is healthier for people not to drink these particles. What is needed is an economical device that will screen these particles out of drinking the water and prevent them from being ingested by people.

When people touch faucet handles to turn on the water to wash their hands, some of the germs on their hands are transferred to the faucet handles. After washing their hands, the person then touches the faucet handles to turn off the water unknowingly transferring germs back onto their hands, this is referred to as cross-contamination. In order to reduce the spread of germs, faucet (tap) handles must not be touched. What is needed is an economical, durable device that will allow people to wash their hands without touching faucet handles thereby reducing the risk of cross-contamination.

To reduce the waste of water and to reduce cross-contamination during the processes described above several types of water control devices have been deployed. For example, in public restrooms, proximity sensors (Infrared devices) interface with a solenoid valve are used to allow water flow only when a person's hands are beneath the faucet. Infrared faucets does conserve water and reduce cross-contamination but are not economically viable for most situations, are not reliable and are difficult to install. Other devices available to help conserve water and reduce cross-contamination are foot or knee operated water controls. These devices are expensive to install and not practical for most situations. None of these types of devices prevent small particles from being ingested by people drinking water from faucets or taps.

Another device for reducing the waste of water is a wand activated dispensing valve as described in U.S. Pat. No. 5,286,000 to Katz which is hereby incorporated by reference. In this, the aerator is removed from the faucet and replaced with an aerator/valve combination. The valve in this device is actuated by a wand or shaft. When the user needs water, the wand is displaced in a sideward direction, thereby opening a valve within the aerator/valve assembly. When the user is finished, pressure is released from the wand and the valve slams shut sealing under the top surface of the valve and the water stops. Due to the top seal design of the valve, a phenomena known as water hammer occurs when the valve closes. Water hammer often occurs when the flow of water is abruptly halted. The aerator/valve described here is also not reliable or durable and frequently fails under normal use situations. Additionally, the rod on this device is not designed to allow the user to easily move it with the users thumb to reduce cross-contamination and this device does not screen out particles.

A related device describes a rod activated valve for saving water in U.S. Pat. No. 7,975,985, to Gordon, which is hereby incorporated by reference; however, this device is not capable of filtering water.

What is needed is a rod activated valve that is reliable, durable, reduces water hammer, capable of preventing particles over a certain size from passing through the device (filtering the water) and having a rod that is designed to make it easy to use with the back of your thumb thereby reducing cross-contamination.

### SUMMARY OF THE INVENTION

This invention, in one embodiment, provides a water flow chamber having a solid cylindrical outer surface. The water flow chamber has a substantially flat foraminous surface at one end and an aperture located substantially central to the flat foraminous surface. The water flow chamber has a top edge with a lip. The one end of the water flow chamber is held within the cylindrical valve housing by the lip. The water flow chamber has a rod having a rod head at one end. The rod passes through the aperture and is held in place by an upper flow guide, upper valve plate and an upper valve plate O-ring. The upper flow guide has water flow openings. The upper flow guide and upper valve plate are held within the water flow chamber. The upper valve plate interfaces within the lip of the water flow chamber. The upper flow guide and the upper valve plate have a valve aperture. The valve stem is fitted within the valve aperture. The valve stem has an enlarged end, an angled body and a valve base end. The enlarged end of the valve stem and the upper valve plate selectively block a flow of water through the valve aperture; wherein the valve plate O-ring fits into the opening in the upper valve plate and is held securely into position by an undercut groove in the upper valve plate; whereas the valve base interfaces with the rod head such that lateral movement of the rod displaces the rod head, thereby pushing upward on the valve base resulting in the valve stem lifting thereby enabling a flow of water between the valve stem and the valve aperture, and a water filter element configured to block particles from passing thorough the water flow chamber.

This invention, in another embodiment provides a rod activated water valve made of a valve base, a top end of the valve base being threaded on an outside surface for mating with a water faucet thread arrangement, a second end of the valve base having a threaded outside surface; a water flow chamber having a solid cylindrical outer surface, the water flow chamber having a substantially flat foraminous surface at one end, an aperture located substantially central to the flat foraminous surface having a lip on a top edge of the water flow chamber; a rod having a rod head at one end, the rod passing through the aperture and held within the aperture by the rod head; and a means for selectively blocking the flow of water from the water faucet to the water flow chamber and a water filter element forming a seal against the upper valve plate and the cylindrical valve.

In another embodiment a rod activated water valve that can provide continuous water flow without having to press the rod head. In this embodiment, the foraminous surface has a central through aperture which receives the rod. The aperture is substantially rounded with opposite notches to allow space for the outwardly projecting tabs to fit into the aperture. When the rod is pushed directly upward toward the threaded adaptor and twisted in either direction the water will remain on without having to continue to press the rod. To stop the flow of water the rod is twisted and the tabs will drop down into aperture and the flow of water stops.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a conventional faucet set used for dispensing hot and cold water adapted with an embodiment of the present invention for a particular use.

FIG. 2 illustrates a conventional faucet set used for dispensing hot and cold water adapted with an embodiment of the present invention for a particular use.

FIG. 3 illustrates a conventional faucet set used for dispensing hot and cold water adapted with an embodiment of the present invention for a particular use.

FIG. 4 illustrates a conventional faucet set used for dispensing hot and cold water adapted with an embodiment of the present invention.

FIG. 5 illustrates a rod activated valve of the present invention.

FIG. 6 illustrates an exploded view of the rod activated valve of the present invention.

FIG. 7A illustrates a view of the water filter element.

FIG. 7B illustrates a view of the water filter element.

FIG. 7C illustrates a view of the water filter element.

FIG. 7D illustrates a view of the water filter element

FIG. 8 illustrates an exploded view of the rod activated valve of the present invention.

FIG. 9 illustrates a portion of the rod activated valve of the present invention.

FIG. 10 illustrates an exploded view of the rod activated valve of the present invention.

### DETAILED DESCRIPTION OF THE INVENTION

The present invention may be understood more readily by reference to the following detailed description of the invention. It is to be understood that this invention is not limited to the specific devices, methods, conditions or parameters described herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

These and other aspects, features and advantages of the invention will be understood with reference to the detailed description herein, and will be realized by means of the various elements and combinations particularly pointed out in the appended claims. It is to be understood that both the foregoing general description and the following detailed description of the invention are exemplary and explanatory of preferred embodiments of the inventions, and are not restrictive of the invention as claimed. Unless defined otherwise, all technical and scientific terms used herein have the same meaning as commonly understood by one of ordinary skill in the art to which this invention belongs. Reference will now be made in detail to the presently preferred embodiments of the invention, examples of which are illustrated in the accompanying drawings. Throughout the following detailed description, the same reference numerals refer to the same elements in all figures.

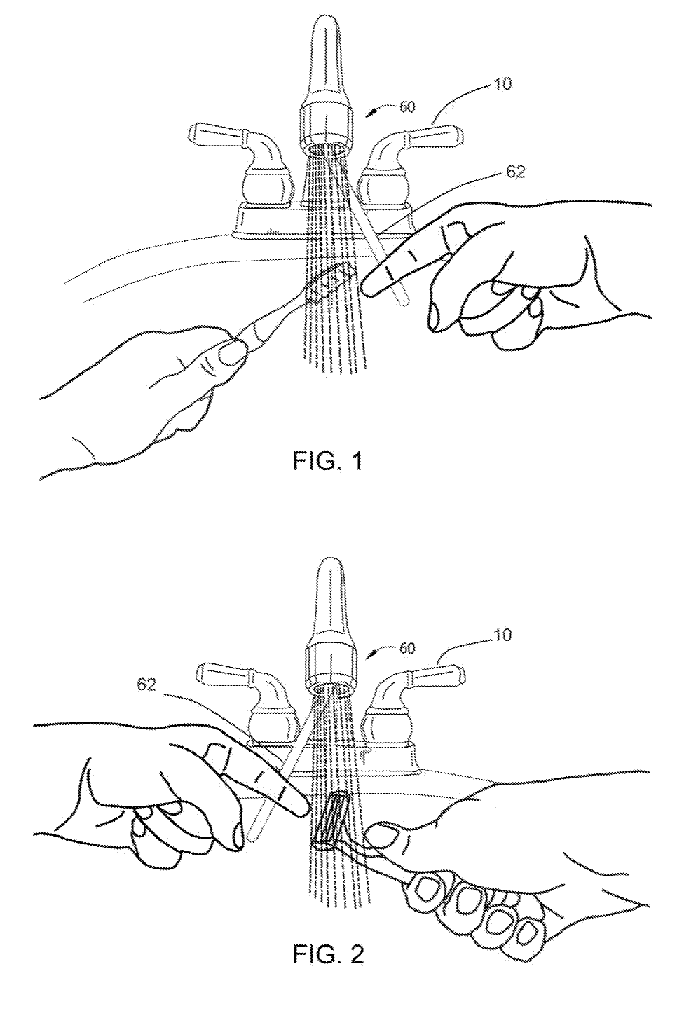

Referring to FIG. 1, the improved rod activated valve 60 is shown for use on a bathroom faucet 10 to brush teeth and to wash a tooth brush, while FIG. 2, shows the improved rod activated valve 60 is shown for use on a bathroom faucet to wash a razor, while shaving with a razor.

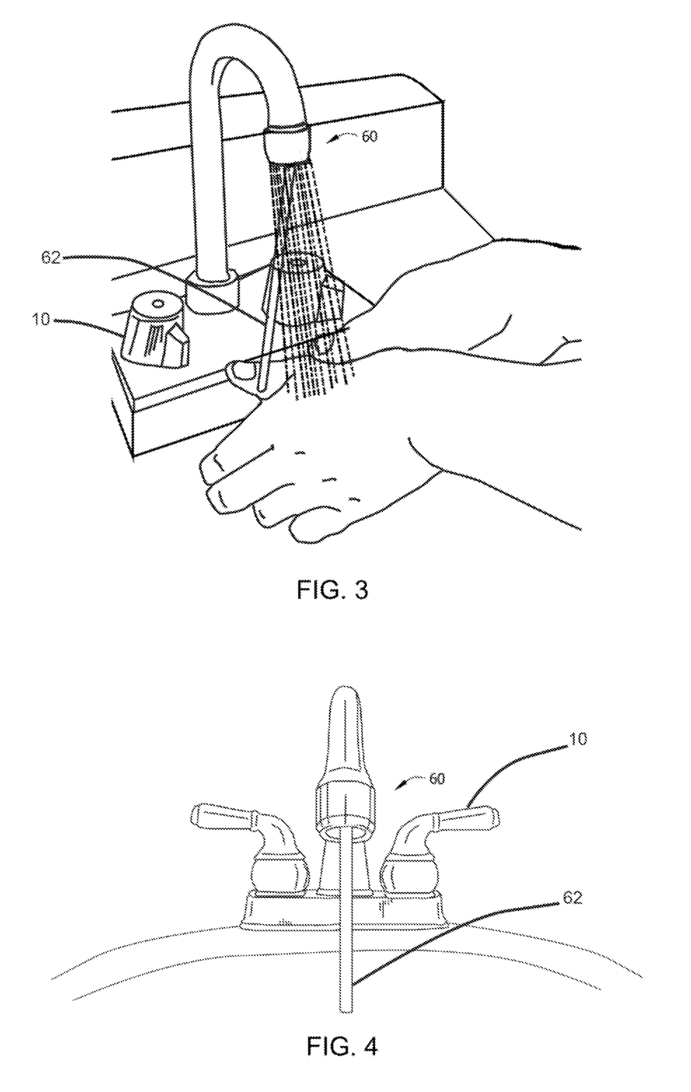

Referring to FIG. 3, the improved rod activated valve is shown for use on a hand-wash faucet 10 to wash hands, while FIG. 4, shows the improved rod activated valve 60 not in use.

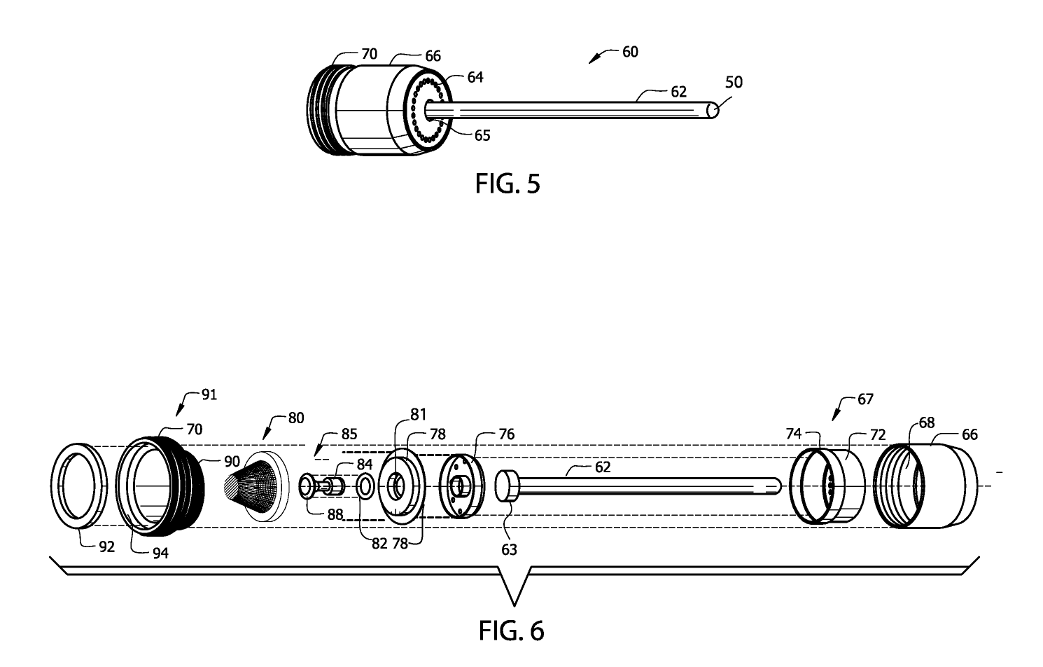

Referring now to FIG. 5, a rod activated valve 60 of the present invention is shown. Visible is the housing 66. At one end of the housing 66 is a foraminous surface 64 of the water flow chamber 67 (see FIG. 6) which is held in place by a narrowing diameter of the housing 66 at its lower end. The foraminous surface 64 has a central through aperture 65 which receives the rod 62. The aperture 65 is preferably centrally located on the lower foraminous surface 64. Holes in the lower foraminous surface 64 direct the water in a straight downwardly direction to increase the velocity of the water and to control splashing.

The top end of the rod activated valve 60 is threaded 70 for mating with the internal threads of a faucet (FIGS. 1-4). The inside top of the housing 66 is also threaded to allow the rod activated valve to be installed onto external threaded faucets. The thread size on part 70 may be modified to allow it to fit on any threaded faucet or threaded pipe in the world. In some embodiments, the rod is made of stainless steel or unbreakable plastic.

Referring now to FIGS. 6 and 8, an exploded view of the rod activated valve 60 of the present invention is shown. A substantially cylindrical housing 66 has at one end a water flow chamber 67 having a lower foraminous surface 64 and a central through aperture 65 which receives the rod 62. The water flow chamber 67 has a substantially solid, cylindrical side surface 72 for fitting within the housing 66. A lip 74 is formed on the side surface 72 for holding the water filter element 80 in its correct position.

An upper flow guide 76 and an upper valve plate 78 having a circumferential groove both fit within the water flow chamber 67. The smaller diameter of the upper valve plate 78 fits within the inner diameter of the threaded adaptor 91. The valve stem 85 has an enlarged end 88. The upper valve plate o-ring 82 fits into the opening in the upper valve plate 78 and is held securely into position by an undercut groove 81 on the outside edge of the small opening in the center of the upper valve plate.

The angled surface of the valve 88 seals against the inside edge of o-ring 82 provides for a gradual reduction of water flow when the valve 60 is not being pushed off the o-ring 82 by the rod head 63 thereby reducing water hammer. At the opposite end of the valve stem 85 is a valve base 84. The valve base 84 interfaces with the rod head 63 such that when the rod 62 is displaced, the edge of the rod head 63 pushes against the valve base 84 and lifts the valve stem 85 out of its seat on the upper valve plate 78, thereby allowing water to flow. The lip 74 of the water flow chamber 67 interfaces with the outer edge of the upper valve plate 78.

The top end of the rod activated valve 60 has a threaded adaptor 91 with threads 90 for attaching the housing 66 and threads 70 for mating with the threads of a faucet (not shown). A washer 92 fits within a recess 94 at the top end of the threaded adaptor 91. By fitting the recessed washer 92 in a recess 94, the recessed washer 92 is held in position while the rod activated valve 60 is installed into or onto a faucet spout. A substantially cylindrical housing 66 has at one end a water flow chamber 67 having a lower foraminous surface 64, and a central through aperture 65 (not visible) which receives the rod 62. The aperture 65 is preferably centrally located on the lower foraminous surface 64 but does not have to be completely round on all sides. The water flow chamber 67 has a substantially solid, cylindrical side surface 72 for fitting within the housing 66. A lip 74 is formed on the side surface 72 for holding the upper valve plate O-ring 82 in its correct position.

An upper flow guide 76 and the upper valve plate 78, having a circumferential groove, both fit within the water flow chamber 67. The valve a-ring 82 is held securely into the upper valve plate by the undercut. The larger diameter of the water filter washer base 83 fits tightly onto the smaller diameter of the upper valve plate 78 fits to create a water tight seal against the inner diameter of the threaded adaptor 91 and the threads on the inner part of the cylindrical housing 66. The valve stem 85 has an enlarged end 88 which snaps into 76 and holds the parts 85, 82, 78 and 76 together. The angled surface 86 of the valve stem 85 seals against the inside of a-ring 82 to provide for a reduction of water flow when the valve 60 is closed, thereby reducing water hammer. As water pressure increases the valve stem 85 is pressed deeper onto the O-ring 82 causing the valve stem 85 to seal against the underside of the valve 88 creating a double seal.

At the opposite end of the valve stem 85 is a valve base 84. The valve base 84 interfaces with the rod head 63 such that when the rod 62 is displaced, the edge of the rod head 63 pushes against the valve base 84 and lifts the valve stem 85 out of its seat on the upper valve plate 78, thereby allowing water to flow. The lip 74 of the water flow chamber 67 interfaces with the outer edge of the upper valve plate 78.

The top end of the rod activated valve 60 has a threaded adaptor 91 with threads 90 for attaching the cylindrical housing 66 and threads 70 for mating with the threads of a threaded faucet (not shown). A recessed washer 92 fits within a recess 94 at the top end of the threaded adaptor 91. By fitting the recessed washer 92 in a recess 94, the recessed washer 92 is held in position while the rod activated valve 60 is installed into a faucet spout.

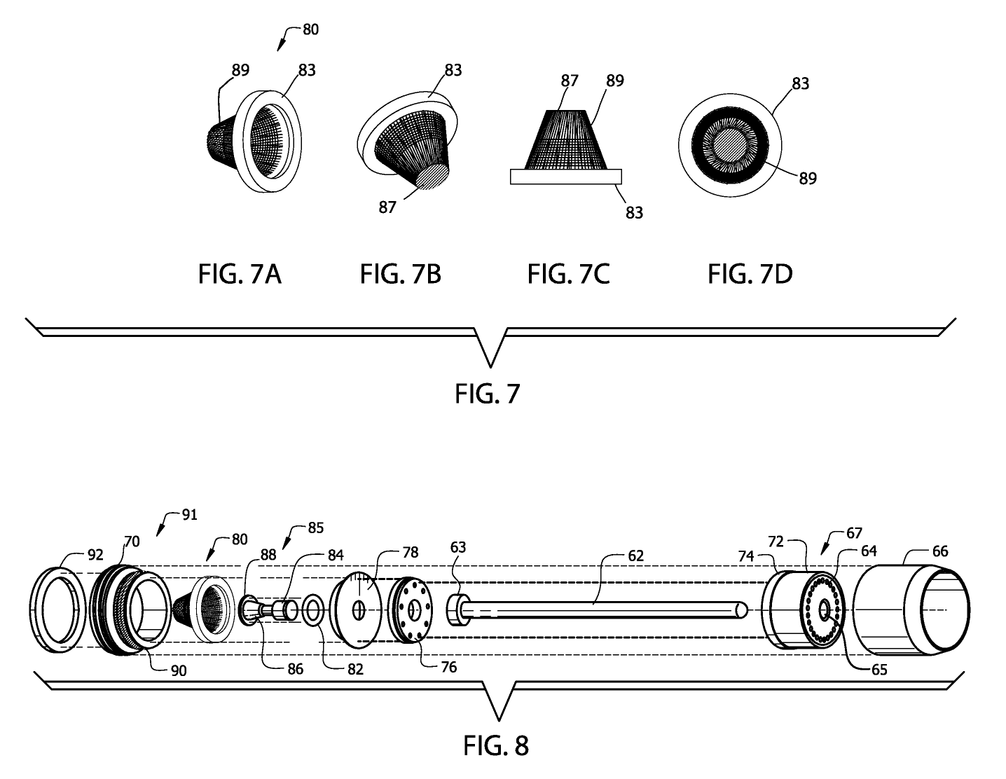

Referring to FIGS. 7A-7D, in addition to automatically shutting-off water, when pressure is released from the rod 62, a water filter element 80 will prevent any particle larger than the filter mesh from passing through the filter and moving through the rod activated water valve 60 and ending up in the drinking water. The stainless steel filter mesh, or other filter material, will block particles larger than the mesh used from passing through the water control and being unknowingly added into drinking water.

People in most countries around the world drink water that has impurities in it. Many countries have particles of dirt, limestone and other impurities floating through water pipes. People would prefer not to drink these particles. By adding a water filter element 80 these particles can be prevented from passing through the rod activated water valve 60 and being ingested.

Filter element 80 is configured to allow the valve stem 85 to freely move up and down without having its movement being restricted by the water filter element 80. The filter element 80 is a substantially pyramid or coned shaped or any raised shape that is not flat, that functions to allow free movement of the valve stem 85. The pyramid shape of the water filter element 80 maximizes the surface area of the filter increasing its water filter capabilities. The increased surface area of the water filter also lengthens the time between filter cleaning. The configured portion 89 of the filter element 80 can be made from a stainless steel mesh.

The water filter element 80 prevents particles from lodging between the valve stem 85 and the small o-ring 82 which can cause product failure. The bottom portion 83 of the water filter element 80 is made of washer or o-ring material, for example an elastomeric material, so that it creates a water tight seal against the upper valve plate 78 and the inside edge of the housing 66. This bottom portion 83 also holds the stainless steel mesh into a permanent shape and creates a blanket barrier around the valve stem 85.

The top portion 87 of the shaped water filter element 80 can be flat to maximize its strength, maximize surface area of the filter mesh and to make it easy to remove and clean without damaging the water filter element 80. However, in an alterative embodiment it can be rounded. A rod activated water valve 60 will operate longer without failure with the water filter element 80 than one without a filter.

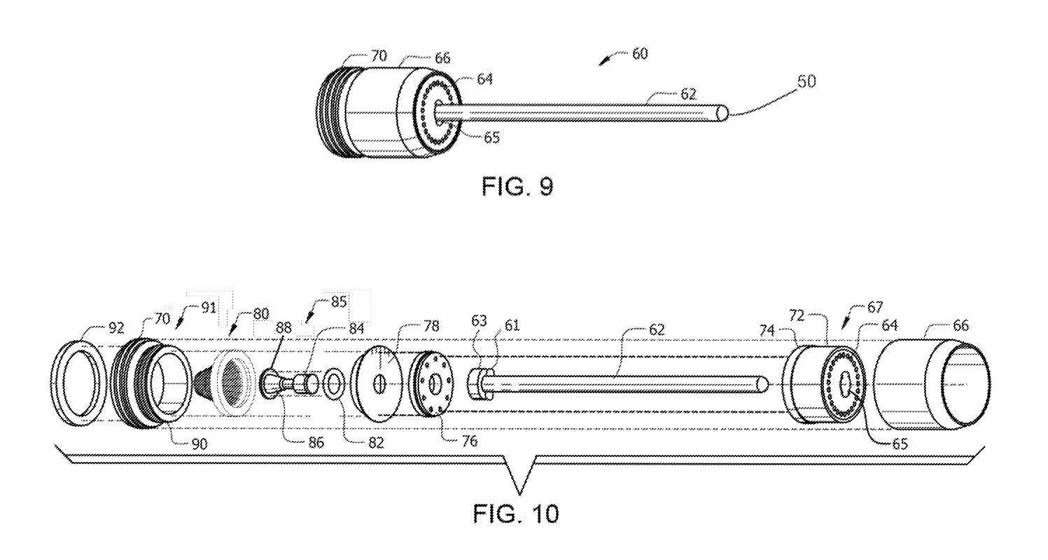

Referring to FIGS. 9 and 10, another embodiment is shown. This embodiment shows a means to provide continuous water flow without having to press the rod head. The foraminous surface 64 has a central through aperture 65 which receives the rod 62. In this embodiment, the aperture 65 is substantially rounded with opposite notches to allow space for the outwardly projecting tabs 61 to fit into aperture 65. When the rod 62 is pushed directly upward toward threaded adaptor 91 and twisted in either direction the water will remain on without having to continue to press the rod 62. To stop the water, twist the rod 62 and the tabs 61 will drop down into aperture 65 and the water will stop.

Equivalent elements can be substituted for the ones set forth above such that they perform in substantially the same manner in substantially the same way for achieving substantially the same result. It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An apparatus comprising:
a water flow chamber having a solid cylindrical outer surface, the water flow chamber having a substantially flat foraminous surface at one end, an aperture located substantially central to the flat foraminous surface, a water flow chamber top edge having a lip, the one end of the water flow chamber held within the cylindrical valve housing by the lip;
a rod having a rod head at one end, the rod passing through the aperture and held in place by the]
an upper flow guide, upper valve plate and an upper valve plate o-ring, the upper flow guide having water flow openings, the upper flow guide and upper valve plate held within the water flow chamber, the upper valve plate interfacing within the lip of the water flow chamber, the upper flow guide and the upper valve plate having a valve aperture;
a valve stem fitted within the valve aperture, the valve stem having an enlarged end, an angled body and a valve base end; the enlarged end of the valve stem and the upper valve plate selectively block a flow of water through the valve aperture; wherein said valve plate o-ring fits into the opening in the upper valve plate and is held securely into position by an undercut groove in the upper valve plate; whereas the valve base interfaces with the rod head such that lateral movement of the rod displaces the rod head, thereby pushing upward on the valve base resulting in the valve stem lifting thereby enabling a flow of water between the valve stem and the valve aperture, and
a water filter element configured to block particles from passing thorough the water flow chamber.

2. The apparatus of claim 1, wherein said water filter element is configured to allow the valve stem to freely move up and down.

3. The apparatus of claim 1, wherein said water filter element forms a seal against the upper valve plate and the cylindrical valve.

4. The apparatus of claim 1, wherein said water filter element has a top portion and bottom portion, wherein said bottom portion is a washer or o-ring material and said top portion is flat.

5. The apparatus of claim 1, wherein said water filter element has a configured portion and said configured portion is substantially pyramid, or coned shaped.

6. The apparatus of claim 5, wherein said configured portion of the filter element is made from a stainless steel mesh.

7. The apparatus claim 1, further comprising a means to provide continuous water flow without providing pressure to the rod.

8. The apparatus of claim 7, wherein the aperture is substantially rounded with opposite notches to receive the head of the rod.

9. The apparatus of claim 8, wherein the rod includes a plurality of outwardly projecting tabs configured to fit into said notches.

10. The apparatus of claim 1, wherein a top end of the valve base includes a recess for capturing a recessed washer.

11. A rod activated water valve apparatus comprising:
a valve base, a top end of the valve base being threaded on an outside surface for mating with a water faucet thread arrangement, a second end of the valve base having a threaded outside surface;
a water flow chamber having a solid cylindrical outer surface, the water flow chamber having a substantially flat foraminous surface at one end, an aperture located substantially central to the flat foraminous surface having a lip on a top edge of the water flow chamber, said water flow chamber including a water filter element configured to block particles from passing thorough the water flow chamber;
a rod having a rod head at one end, the rod passing through the aperture and held within the aperture by the rod head; and
means for selectively blocking the flow of water from the water faucet to the water flow chamber.

12. The apparatus of claim 11, wherein said water filter element is configured to allow the valve stem to freely move up and down.

13. The apparatus of claim 11, wherein said water filter element forms a seal against the upper valve plate and the cylindrical valve housing.

14. The apparatus of claim 11, wherein said water filter element has a top portion and bottom portion, wherein said bottom portion is a washer or o-ring material and said top portion is flat.

15. The apparatus of claim 11, wherein said water filter element has a configured portion and said configured portion is substantially pyramid, or coned shaped.

16. The apparatus of claim 15, wherein said configured portion of the filter element is made from a stainless steel mesh.

17. The apparatus of claim 16, wherein said configured portion of the filter element is made from a stainless steel mesh or other filter material.

18. The apparatus of claim 11, wherein the means for selectively blocking the flow of water includes a valve seat having an upper valve plate, a upper valve plate o-ring and a upper flow guide, the upper valve plate and a upper flow guide held within the water flow chamber, the upper valve plate held in the lip of the water flow chamber, a groove of the upper valve plate fitting within the second end of the valve base, the upper flow guide and the upper valve plate having a valve aperture, wherein the upper flow guide has a foraminous surface for passing water from the valve aperture to the water flow chamber.

19. The apparatus of claim 11, wherein the means for selectively blocking the flow of water includes a valve stem fitted within the valve aperture, the valve stem having an enlarged end, an angled body and a valve base.

20. The apparatus claim 11, further comprising a means to provide continuous water flow without providing pressure to the rod.

21. The apparatus of claim 20, wherein the aperture is substantially rounded with opposite notches to receive the head of the rod.

22. The apparatus of claim 21, wherein the rod includes a plurality of outwardly projecting tabs configured to fit into said notches.
